(19) United States
(12) Patent Application Publication
(10) Pub. No.: US 2003/0022745 A1
(43) Pub. Date: Jan. 30, 2003

(54) Multi-spindle drive and belt tensioning assembly

(76) Inventor: Richard Kuchta, Shickshinny, PA (US)

Correspondence Address: McCormick, Paulding & Huber, City Place II, 185 Asylum Street, Hartford, CT, 06103-3402, US

(21) Appl. No.: 09/916,003

(22) Filed: Jul. 26, 2001

(51) Int. Cl. F16H 7/08; F16H 7/22; F16H 7/14

(52) U.S. Cl. 474/101; 474/119; 474/114; 474/113

(57) ABSTRACT

In a multi spindle drive belt tensioning assembly a motor is mounted to a frame and the drive pulley is coupled for rotation to the motor shaft. At least two driven pulleys are each coupled to a driven member rotatably mounted to the frame. The driven pulleys are spaced apart relative to one another and at least one belt is in engagement with the drive pulley and each of the driven pulleys. In either pulley is rotatably coupled to the frame between two of the driven pulleys and engageable with the belt. The idler pulley is movable relative to the belt to increase or decrease the tension thereof and the degree of engagement between the belt and the driven pulleys. The idler pulley is adjustable relative to the belt to allow a desired belt tension in engagement between the belt and the driven pulleys such that the belt extends approximately 180 degrees around the circumference defined by each of the driven pulleys.

### FIELD OF THE PRESENT INVENTION

The present invention is generally directed to belt driven machinery and is more specifically directed to machinery having multiple belt driven components.

### BACKGROUND OF THE PRESENT INVENTION

The present invention has general utility with respect to machinery that incorporates belt driven components and is particular useful with respect to machinery employing multiple belt-driven spindles. One such machine is a triple drill, a drill having three independently operable spindles each adapted to releasably retain a drill bit. However, while the apparatus described and illustrated herein below is particularly suitable for use with the present invention, it should be understood that the invention is not limited in this regard. The present invention may be used with any multi-spindle, belt-driven machinery.

In general, machine tools such as drilling machines, milling machines, and the like, employ belt driven spindles adapted to releasably retain a cutting tool. During a cutting operation, high torques are generated and transmitted through the spindle, the pulley coupled thereto, and ultimately to the belt driving the spindle. The amount of force that can be accommodated by the belt is a function of the degree of contact between the belt and the pulley with which it is engaged. However, because the pulley attached to the drive motor and the pulley attached to the spindle generally define different outer diameters, optimal belt contact with the spindle pulley is difficult to achieve.

This problem is exacerbated when a single belt is used to drive multiple spindles. In this situation the belt is often wrapped around the spindles in convoluted patterns, sometimes making minimal contact with each pulley. This reduces the torque transmission, capabilities of the belt often resulting in the belt slipping on the pulley. One manner of addressing this problem is to employ a separate belt for each driven pulley. While this may allow for greater torque carrying capacity in the belts, it is often difficult to have more then two belts driven by a single drive pulley without the pulleys becoming inordinately large. Accordingly, minimizing the number of drive belts required, reduces the complexity and thereby the manufacturing cost of a multi-spindle, belt-driven machine. Another difficulty sometimes encountered where a single belt is employed to drive multiple pulleys is that it is difficult to maintain the appropriate belt tension from pulley-to-pulley. Attempts to address this problem have been made using belttension devices that generally engage the belt along the portion thereof that is in tensions during operation of the machine with which the belt is associated. Where a single belt engages multiple pulleys, multiple tensioners may be required. Even if multiple tensioners are used, the problems associated with gaining adequate contact between the belt and pulleys still exists.

Based on the foregoing, it is the general object of the present invention to provide a multi-spindle drive system that overcomes the problems and drawbacks of prior art systems.

### SUMMARY OF THE PRESENT INVENTION

The present invention is directed in one aspect to a multi-spindle drive and belt tensioning assembly that includes a frame having a drive motor mounted thereto. A drive pulley is coupled for rotation, to a shaft extending outwardly from the motor. At least two driven pulleys are each coupled to a driven member that in turn is rotatably mounted to the frame. The driven pulleys are spaced apart relative to one another with an idler pulley coupled to the frame between the two driven pulleys. At least one belt is provided and engages the drive and driven pulleys. The idler pulley is movable relative to the belt to increase or decrease the tension thereof and the amount by which the belt contacts each of the driven pulleys. Adjustment means are provided to facilitate the movement of the idler pulley relative to the belt so that the belt engages each of the two driven pulleys over approximately 180° of a circumference defined thereby.

In the preferred embodiment of the present invention, the multi-spindle drive includes three driven pulleys each coupled to a spindle that in turn is rotatably coupled to the frame. A first belt engages each driven pulley, and the drive pulley. A second belt extends around the drive pulley and two of the three driven pulleys. A spacer provided on the drive pulley between the first and second belts prevents the belts from touching during operation. The idler pulley is positioned between the two driven pulleys adjacent to the second belt which is movable relative to the driven pulleys to tension the second belt and to position the second belt relative to the two driven pulleys so that the belt contacts the driven pulleys over approximately 180° of the outer periphery of each.

### BRIEF DESCRIPTION OF THE DRAWINGS

FIG. 1 is a partial front elevational view of a triple drill embodying the present invention.

FIG. 2 is a partial cross sectional, side elevational view of the triple drill of FIG. 1.

FIG. 3 is a partial cross-sectional view taken along lines 3-3 of FIG. 2, showing the drive and driven pulleys as well as a first and second belt, the second belt being engaged by an idler pulley.

FIG. 4 is a side elevational view of the idler pulley and bracket of FIG. 3 showing the means for adjusting the position of the idler pulley.

FIG. 5 is an exploded view showing the spindle assembly having one of the driven pulleys of FIG. 4 attached thereto.

### DETAILED DESCRIPTION OF THE PREFERRED EMBODIMENTS OF THE PRESENT INVENTION

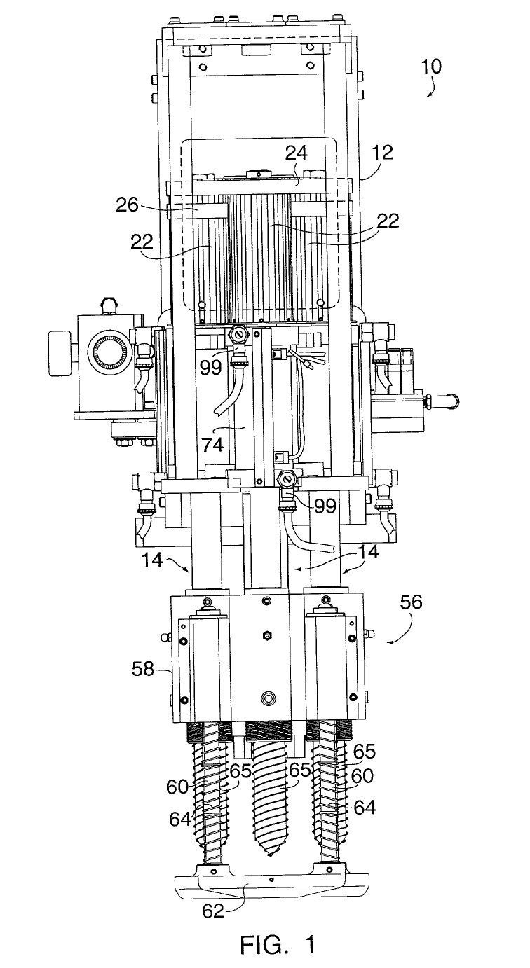

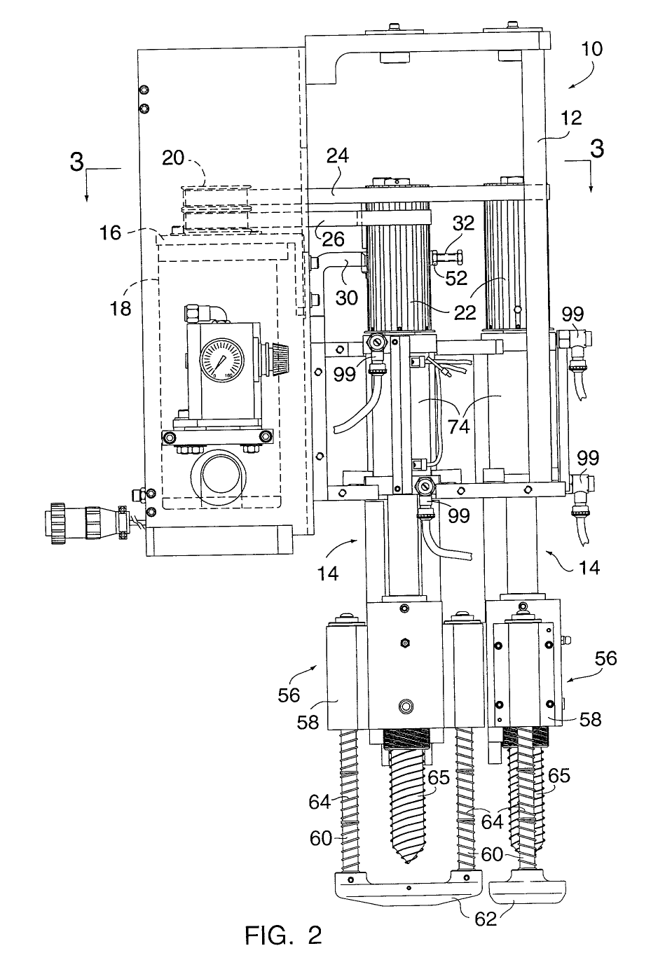

As shown in FIGS. 1 and 2, a triple drill generally designated by the reference number 10 includes a housing 12, and three separate spindle assemblies, explained in detail herein below and generally designated by the reference number 14. Referring to FIG. 2, a motor bracket 16 is attached to the housing 12 and has a motor 18 (shown in dotted lines in FIG. 2) fastened thereon.

A drive pulley 20 (also shown in dotted lines in FIG. 2) is coupled for rotation to the motor 18. In addition, a driven pulley 22 is mounted for rotation to each of the spindle assemblies 14.

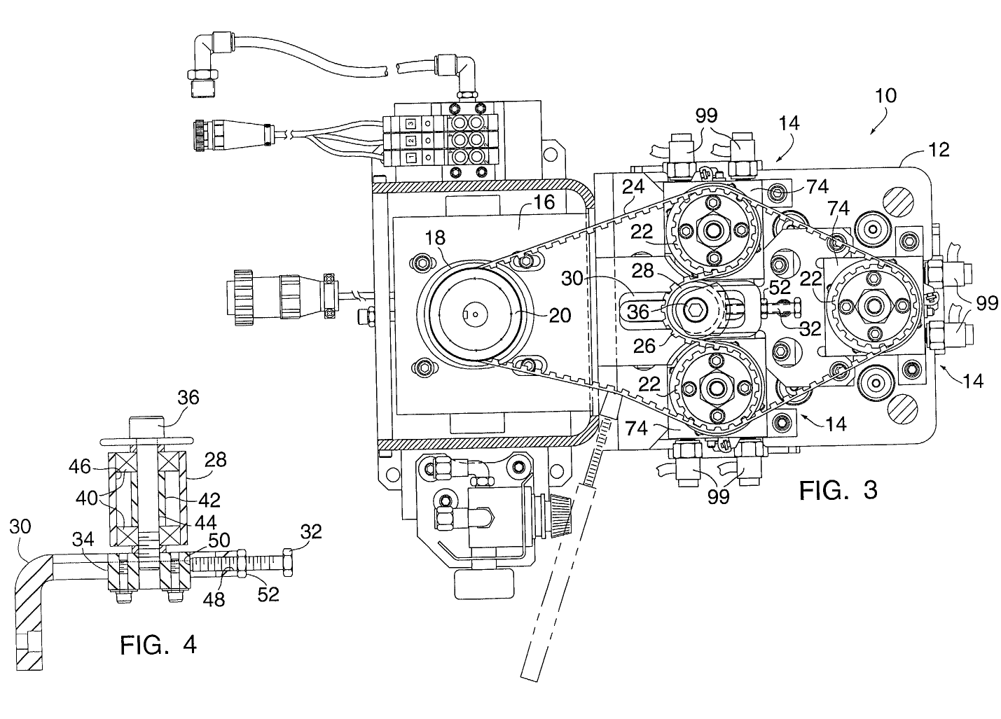

As shown in FIGS. 1 and 2, and particularly in FIG. 3, a first drive belt 24 extends around the drive pulley 20 and each driven pulley 22. The driven pulleys 22 are arranged in a triangular pattern with the drive pulley 20 being positioned opposite to and aligned with the driven pulley 22 forming the apex of the triangular pattern, as such, the first belt 24 minimally engages the periphery of the driven pulleys 22 closest to the drive pulley and extends approximately half or 180° around the periphery of the driven pulley at the apex of the triangular pattern. During operation, the driven pulley 22 at the apex of the triangular pattern is sufficiently engaged by the first belt 24 to transmit an appropriate operating torque to the spindle 14 to which it is coupled. However, the two driven pulleys 22 closest to the drive pulley 20 are not sufficiently engaged by the first belt 24 to transmit the desired operating torque. Accordingly, a second belt 26 engages the drive pulley 20 and the two driven pulleys 22 closest thereto.

Still referring to FIG. 3, it is preferable that the two driven pulleys 22 closest to the drive pulley 20, be engaged by the second belt 26 over approximately 180 degrees of the peripheries defined by each driven pulley. To accomplish this, the second belt 26 must be deformed between the driven pulleys 22. Thus is facilitated by an idler pulley 28 mounted for rotation to a bracket 30 that in turn is mounted to the frame 12. The idler pulley 28 is movable relative to the frame 12 by turning the adjusting screw 32, to increase, or decrease, depending on the direction in which the adjusting screw is turned, the tension in the second belt 26, as well as to increase or decrease the amount of belt engagement between the second belt 26 and the driven pulleys 22. While cog type belts and pulleys have been shown and described in the illustrated embodiment, the present invention is not limited in this regard as other types of belts and pulleys, known to those skilled in the pertinent art to which the present invention pertains, may be substituted without departing from the broader aspects of the present invention. For example, V-belts and sheaves, or flat belts and pulleys can be employed in place of the above-described cog belts and pulleys.

As shown in FIG. 4 the idler pulley 28 is mounted to the bracket 30 via a support 34. A fastener 36 extends through the idler pulley 28 and threadably engage the support 34. A pair of bearings 40 separated by a spacer 42 are located over an outer diameter 44 defined by a fastener 36 and engage an inner diameter 46 of the idler pulley 28. The adjusting screw 32 threadably engages an aperture 48 defined by the bracket 30 and includes an end 50 that engages the support 34. A lock nut 52 is threaded onto the adjusting screw 32 and can be tightened against the bracket 30 to releasably lock the idler pulley in a desired location.

Referring back to FIGS. 1 and 2, the triple drill 10 includes three spindle assemblies 14 generally parallel with one another and extending outwardly from the housing 12. Each of the spindle assemblies 14 is mounted for rotation to the frame and has a presser foot assembly generally designated by the reference number 56 mounted thereon. Each presser foot assembly 56 includes a presser foot support 58 having a pair of guide rods 60 slidably extending therefrom. A presser foot 62 is attached to the ends of the pair of guide rods 60 and a coil spring 64 is positioned over each guide rod 60 between the presser foot 62 and the presser foot support 58. During operation of the triple drill 10, one of the spindle assemblies 14, which are movable between a raised and a lowered position, is moved into engagement with the media to be drilled. Depending on the thickness of the media, the presser foot 62 via the pair of guide rods 60 sliding into or out of the presser foot support 58 moves up or down and is urged toward the media via the springs 64. As will be explained in detail a portion of the spindle assembly, having a cutting tool 65, shown in the illustrated embodiment as a drill bit is lowered so that the drill engages and machines the media to be drilled.

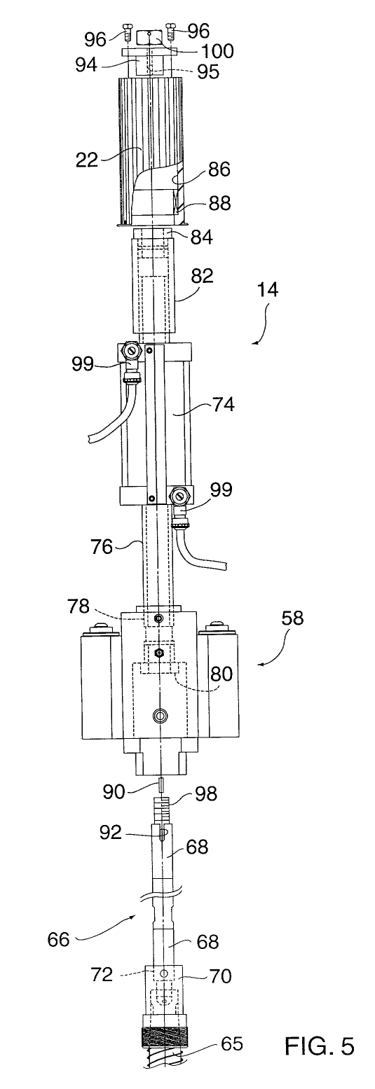

As shown in FIG. 5, the spindle assembly 14 includes a spindle shaft generally designated by the reference number 66 having bearing journals 68 machined at opposite ends thereof. A chuck 70 adapted to releasably retain the cutting tool 65 is mounted on an end 72 of the spindle shaft. An actuator 74, shown in the illustrated embodiment as a pneumatic cylinder, includes a cylinder rod 76 through which the spindle shaft 66 passes. The presser foot support 58 is mounted on an end 78 of the cylinder rod 76. When the spindle shaft 66 is positioned in the cylinder rod 76, the bearing journal 68 adjacent the chuck 70 engages an inner race of a bearing 80 mounted on the end 78 of the cylinder rod. A sleeve 82 is also mounted to the cylinder rod 76 at the end opposite the chuck 70 via the sleeve 82 is lightly pressed and then pinned to the pneumatic shaft. The bearing 84 in the sleeve engages spindle shaft 66.

Still referring to FIG. 5, each driven pulley 22 defines a bore 86 extending therethrough. The bore 86 is stepped and includes a needle bearing 88 positioned in one end. The sleeve 82 is adapted to be received in the bore 86 with the needle bearing 88 engaging the outer periphery of the sleeve. A key 90 is positioned in keyway 92 defined by the spindle shaft 66 and engages a keyway 95 in bushing 94 which in turn extends partway into the driven pulley 22 and is fastened thereon via fasteners 96. When assembled, the spindle shaft 66 extends through the driven pulley 22 and defines a threaded end 98. A nut 100 engages the threaded end 98 thereby tying the spindle assembly 14 together, and preloads bearings 80 and 84. During operation, the cylinder 74 pneumatically is actuated via ports 99, to move the cutting tool installed in the chuck 72 into engagement with the media to be drilled. Each of the three spindles 66 is independently movable via commands issued from a controller, not shown, in communication with the triple drill 10.

During operation, as a spindle assembly is lowered, the first and second belts, 24 and 26 respectively, slide along the driven pulleys 22 in order to maintain alignment with the drive pulley 20. To facilitate this movement, the driven pulleys 22 are chrome plated and a lubricant, such as silicon is applied. Accordingly during movement of a spindle assembly, the first and second belts, 24 and 26 essentially remain stationary with the driven pulley 24 moving relative thereto.

While preferred embodiments have been shown and described, various modifications and substitutions may be made without departing from the spirit and scope of the invention. Accordingly, it is to be understood that the present invention has been described by way of example, and not by limitation.

What is claimed is:

1. A multi-spindle drive and belt tensioning assembly comprising:
a frame;
a motor mounted to the frame;
a drive pulley coupled for rotation to a motor shaft extending outwardly from said motor;
at least two driven pulleys are each coupled to a driven member rotatably mounted to said frame, said driven pulleys being spaced apart relative to each other;
at least one belt in engagement with said drive pulley and each of said driven pulleys;
an idler pulley rotatably coupled to said frame between said at least two driven pulleys and engagable with said belt, said idler pulley being movable relative to said belt to increase or decrease the tension thereof and the degree of engagement between the belt and the driven pulleys;
adjusting means for moving said idler pulley relative to said belt to allow a desired belt tension and engagement between said belt and said driven pulleys; and wherein
said belt, due to the engagement of said idler pulley, extends approximately 180° around a circumference defined by each of said driven pulleys.

2. A multi-spindle drive and belt tensioning assembly as defined by claim 1 further wherein:
said at least two driven pulleys include a first, second, and third driven pulley, each spaced apart from the other and rotatably coupled to said frame;
said at least one belt includes a first belt in engagement with each of said first, second, and third driven pulleys and said drive pulley; and a second belt extending around two of said first, second, and third driven pulleys and said drive pulley,
said idler pulley is positioned between two of said first, second, and third drive pulleys and movable relative thereto to engage said second belt thereby increasing or decreasing the tension thereof; and wherein
said second belt, due to the engagement there against by said idler pulley, engages each of said two of said first second, and third driven pulleys over approximately 180° of a circumference defined by each of said driven pulleys.

3. A multi-spindle drive and belt tensioning assembly as defined by claim 2 further comprising:
a spacer attached to said drive pulley and located between said first and second belts.

4. A multi-spindle drive and belt tensioning assembly as defined by claim 1 further comprising:
an adjustment bracket mounted to said adjustment bracket;
said idler pulley being slidably coupled to said frame; and
an adjusting screw threadably engaging said bracket and defining an end in communication with said idler pulley such that, depending on the direction of rotation of said adjusting screw, said idler pulley moves toward or away from said belt.

5. A multi-spindle drive and belt tensioning assembly as defined by claim 1 wherein said belt is a cog belt; and
said drive and driven pulleys are adapted to receive said cog belt.

6. A multi-spindle drive and belt tensioning assembly as defined by claim 1 wherein said belt is a v-belt and said drive and driven pulleys are v-belt sheaves.

7. A multi-spindle drive and belt tensioning assembly as defined by claim 1 wherein said belt is a flat belt and said drive and driven pulleys are pulleys adapted to engage a flat belt.

8. A multi-spindle drive and belt tensioning assembly as defined by claim 2 wherein each of said first, second and third driven pulleys are coupled to a spindle assembly rotatably coupled to said frame.

9. A multi-spindle drive and belt tensioning assembly as defined by claim 8 wherein each of said spindle assemblies includes a chuck adapted to releasably retain a cutting tool.

10. A multi-spindle drive and belt tensioning assembly comprising:
a frame;
a motor bracket mounted to said frame;
a motor mounted to said bracket and having a rotatable shaft projecting outwardly therefrom;
a drive pulley coupled to said rotatable shaft;
three spindles each rotatably coupled to said frame and spaced apart relative to one another;
a driven pulley mounted onto each of said spindles, each driven pulley being approximately aligned with the others of said driven pulley and said drive pulley;
a first belt extending partway around each of said drive and driven pulleys;
a second belt extending partway around said drive pulley, and two of said three driven pulleys, said second belt being adjacent to said first belt;
an idler pulley mounted to said frame and rotatable relative thereto, said idler pulley being in engagement with said second belt, and located between the two of said driven pulleys about which said second belt extends;
adjustment means for moving said idler pulley toward and away from said second belt to increase or decrease the tension thereof and the amount of engagement between said second belt and said driven pulleys; and wherein
said second belt, due to the engagement there against by said idler pulley engages each of said two driven pulleys over approximately 180° of a periphery defined by each of said driven pulleys.
